(19) United States
(12) Patent Application Publication
(10) Pub. No.: US 2007/0200309 A1
(43) Pub. Date: Aug. 30, 2007

(54) Implement and material management system

(76) Inventor: James Coppedge, Oak Grove, OR (US)

Correspondence Address: OMIKRON IP LAW GROUP, 16325 BOONES FERRY ROAD , SUITE 105, LAKE OSWEGO, OR, 97035, US

(21) Appl. No.: 11/607,437

(22) Filed: Nov. 30, 2006

(51) Int. Cl. B62B 1/00

(52) U.S. Cl. 280/47.26

(57) ABSTRACT

Disclosed is an apparatus. The apparatus may facilitate management of implements and/or material. Management may include organization and transportation of implements and/or materials. Further, the management may include capability of providing various assisting features, such as but not limited to power.

### BACKGROUND

1. Technical Field

The subject matter disclosed herein generally relates to implement organization, storage, and material management.

2. Information

A common activity that may include the use of implements may be related to horticulture. An example of a horticulture related activity may be gardening. Gardening may involve movement about an area and the use of various implements. These implements may include a wide variety of implements such as, but not limited to, cutting tools, power tools, digging tools, etc. Additionally, gardening may involve handling of various materials, which may be commonly referred to as debris.

Continuing with the example of the activity of gardening, because of the various implements and materials that may be involved, moving about an area, while utilizing the implements and handling of materials, may be difficult. Additionally, storage of the implements and materials may include having an area just to facilitate storage such as, but not limited to, a corner of a garage, shed, a corner of a patio, and the like. Further, the materials may accumulate and become more cumbersome to handle.

### BRIEF DESCRIPTION OF THE DRAWINGS

Embodiments are illustrated by way of example and not by way of limitation in the figures of the accompanying drawings, in which like references may indicate similar elements and in which:

FIG. 1 illustrates a schematic of an apparatus to facilitate management of implements and materials in accordance with one embodiment; and

FIG. 2 illustrates an apparatus to facilitate management of implements and materials in accordance with another embodiment.

### DETAILED DESCRIPTION

In the following description, embodiments will be disclosed. For purposes of explanation, specific numbers, materials, and/or configurations are set forth in order to provide a thorough understanding of the embodiments. However, it will also be apparent to one skilled in the art that the embodiments may be practiced without one or more of the specific details, or with other approaches, materials, components, etc. In other instances, well-known structures, materials, and/or operations are not shown and/or described in detail to avoid obscuring the embodiments. Accordingly, in some instances, features are omitted and/or simplified in order to not obscure the disclosed embodiments. Furthermore, it is understood that the embodiments shown in the figures are illustrative representations and are not necessarily drawn to scale.

References throughout this specification to “one embodiment” or “an embodiment” means that a particular feature, structure, material, and/or characteristic described in connection with the embodiment is included in at least one embodiment. Thus, the appearances of the phrases “in one embodiment“and/or “in an embodiment” in various places throughout this specification are not necessarily all referring to the same embodiment. Furthermore, the particular features, structures, materials, and/or characteristics may be combined in any suitable manner in one or more embodiments.

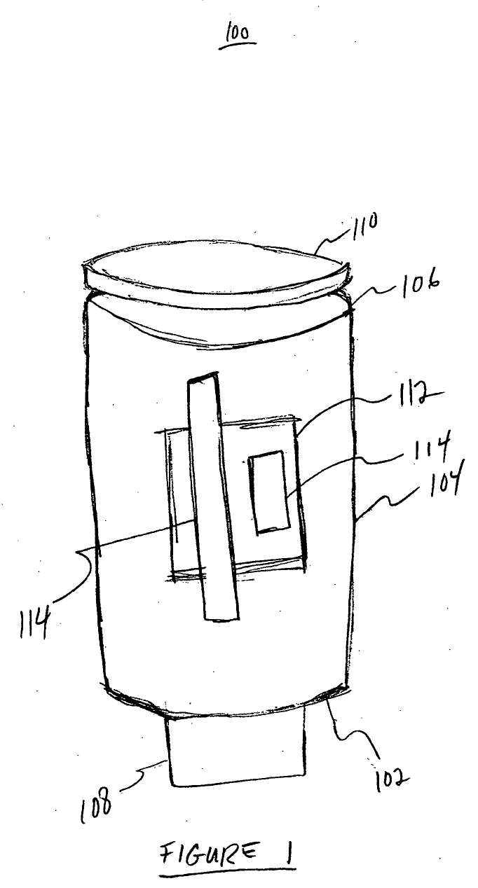

FIG. 1 illustrates a schematic of an apparatus to facilitate management of implements and materials in accordance with one embodiment. Illustrated in FIG. 1 is a container 100 having a bottom 102, a side 104, and a top 106. Additionally, in the embodiment illustrated, the container 100 may have a motion component 108 coupled to the bottom 102, lid component 110 may be coupled to the top 106 of the container 100, and a holding component 112 coupled to the side 104 of the container 100. In addition to the container, examples of some implements 114 may be shown in accordance with embodiments of the subject matter of the disclosure.

Illustrated in FIG. 1, holding component 112 may be capable of holding one or more of implements 114. As will be described in further detail, container 100 may help to facilitate management of the implements 114 in accordance with various embodiments.

In the embodiment illustrated in FIG. 1, container 100 may be shown as having a substantially round shape, but it should be appreciated by those skilled in the relevant art that container 100 may have a wide variety of shapes such as, but not limited to, a substantially rectangular shape. Accordingly, the claimed subject matter is not limited in these respects.

Continuing to refer to FIG. 1, it should be appreciated that the embodiment illustrated may have motion component 108 coupled to substantially a middle portion of the bottom 102, but motion component 108 may be coupled to a wide variety of locations on container 100 such as, but not limited to, substantially one side portion of the bottom 102. Additionally, lid component 110 may be illustrated as being coupled in a substantially separating manner from container 100. However, lid component 110 may be coupled to container in a variety of manners such as, but not limited to, pivotally coupled. Further, in FIG. 1, it should be appreciated by those skilled in the relevant art that the one or more implements 114 may include a wide variety of implements such as, but not limited to, tools, utensils, electrical devices, power cords, and the like, and accordingly, the claimed subject matter is not limited in these respects.

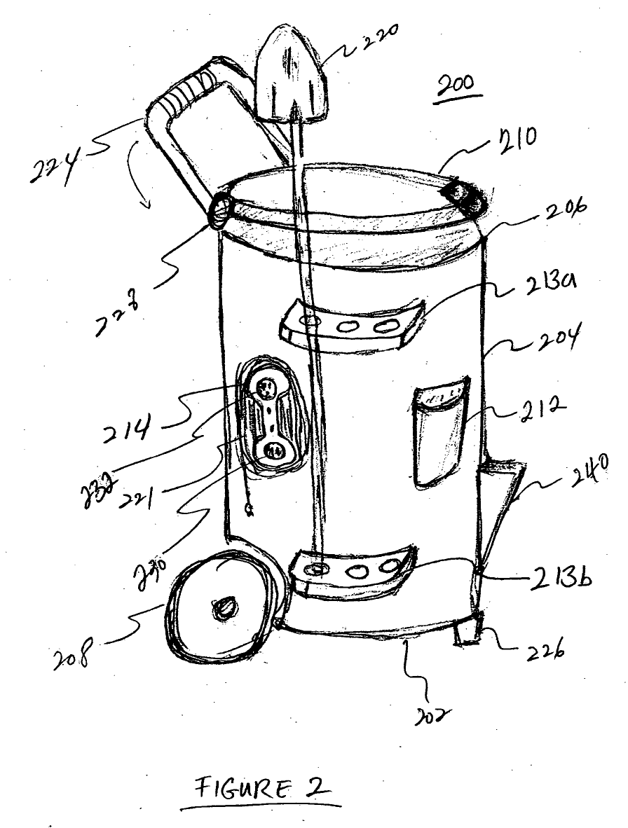

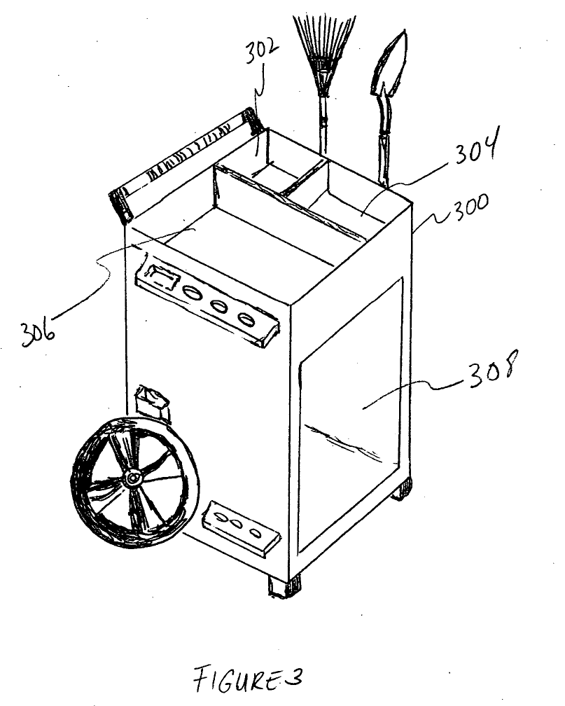

FIG. 2 illustrates an apparatus to facilitate management of implements and materials in accordance with another embodiment. Illustrated in FIG. 2, container 200 may have a bottom 202, a side 204, and a top 206. Container 200 may also have a motion component 208, a lid component 210, and holding components 212-214. Additionally, shown in FIG. 2, are one or more implements 220-221.

In FIG. 2, container 200 may have a support 226, a handle 224, and an opening 240 along the side 204 in accordance with various embodiments. As will be described by way of non-limiting example, container 200 may facilitate management of implements and/or material.

Continuing to refer to the embodiment of FIG. 2, in order to describe the subject matter in more detail, container 200 may comprise of a type of container that may be utilized during an activity of some kind that may include the use of implements such as, but not limited to an activity related to horticulture (e.g., gardening).

As part of the non-limiting example of a container that may be utilized as related to gardening, container 200 may comprise of a plastic yard debris bin type and may have a substantially round shape. Motion component 208 may comprise of two wheels coupled to one or more axels transversely coupled to substantially one side portion of bottom 202 as illustrated in FIG. 2. Lid component 210 may comprise of a lid pivotally coupled to the container 200 (i.e., lid 210 may include a pivot point 228 allowing for pivotally opening and closing the lid 210 on the container 200. Handle 224 may also pivot about pivot point 228 allowing the handle 224 to swing substantially along side 204 when not needed.

Continuing to refer to FIG. 2 as a non-limiting example, holding components 213-214 may have a wide variety of types and applications based at least in part on the activity and implements involved. As shown, holding component 213 may be of the type that may facilitate holding of an elongated type of manual implement such as, but not limited to, a shovel 220. In order to help facilitate holding of a shovel 220, holding component 213 may comprise of a two or more substantially flat parts 213a & 213b with one part 213a towards the top 206 and second part 213b towards the bottom 202 along side 204 of container 200 as shown. A handle of shovel 220 may slide through one part 213a and rest on the second part 213b as shown. In another embodiment, holding component 212 may be of the type that may facilitate holding of power assisted implements such as, but not limited to, an electric hedge trimmer. Accordingly, holding component 212 may be of a pocket type holding component to facilitate holding of various bulky types of implements. In yet another embodiment, holding component 214 may comprise of a holding component to aid in facilitating holding of an electrical type of implement such as, but not limited to, an extension cord 221. Extension cord 221 may be capable of facilitating utilization of electric devices such as, but not limited to, lighting, power assisted implements, and so forth (e.g., a hedge trimmer).

The following may be a non-limiting example of utilization of an embodiment illustrated in FIG. 2 of container 200. Holding components 212-214 may include shovel 220 and extension cord 221 as shown. Container 200 may be utilized to store various implements 220-221, and optionally, handle 224, may be folded along the side 204. Container 200 may be substantially level due to support 226 while being stored and/or stationary. Initial utilization of container 200 may involve unfolding of the handle 224 to a position as shown in FIG. 2, pulling downward on handle 224 to facilitate tilting of the container 200 about wheels 208, and pulling and/or pushing container 200 to a desired location. Once at a desired location, container 200 may facilitate providing power by receiving electrical power via a power reception receptacle 230 (e.g., extension cord 221 may be utilized to draw power from a power source and provide power to holding component 214). In turn, holding component 214 may include a power providing receptacle 232 into which various power assisted implements may be plugged into such as, but not limited to, a hedge trimmer. Alternatively, container 200 may include a self contained type power supply such as, but not limited to, a battery type power supply, solar cell based power supply, and the like. Additionally, shovel 220 may be removed from holding component 213 and may be utilized. Various material such as, but not limited to, yard debris may be deposited into container 200 by way of lid 210. Material and/or implements may be transported by moving container 200 as described previously. Further, material may be removed from within container 200 via opening 240 (i.e., opening 240 may facilitate removal of material from container 200). Alternatively, opening 240 may provide another holding component (e.g., a storage compartment).

FIG. 3 illustrates an apparatus to facilitate management of implements and materials in accordance with yet another embodiment. Illustrated in FIG. 3, a container 300 may not necessarily include a lid component. However, container 300 may include various components as previously described within the scope of the claimed subject matter such as, but not limited to, a motion components, a holding component, etc., and accordingly, is not limited in these respects. Continuing to refer to the embodiment illustrated in FIG. 3, container 300 may include one or more compartments 302-308. As shown, compartments 302-308 may have varying sizes, shapes, and locations. For example, compartment 308 may be relatively large, as compared to the other compartments 302-306, and may be located along a side of the container 300. In another example, compartment 302 may be relatively small, as compared to the other compartments 304-308 and may be located along a top of the container 300. Additionally, as previously described, compartments 302-308 may be covered by a lid component (not shown in the embodiment illustrated in FIG. 3 to better describe the claimed subject matter). Further, each compartment 302-308 may have lid components individually. That is, a lid component may facilitate to cover compartment 302, another lid component may facilitate to cover compartment 304, and so forth, and accordingly, the claimed subject matter is not limited in these respects.

Even though the illustrated embodiment of FIG. 3 may show a substantially rectangular container, it should be appreciated that the claimed subject matter may include a container having a wide variety of shapes such as, but not limited to, substantially cylindrical as previously described.

It should be appreciated by those skilled in the art that even though the above example related to gardening, the claimed subject matter may include various other examples of transportation and storage of tools such as, but not limited to, auto repair, wood working, maintenance, electrical wiring, plumbing, etc. Accordingly, in some embodiments, the container may be made of a wide variety of material such as, but not limited to, plastic and/or metal type material and have a wide variety of shapes such as, but not limited to, substantially rectangular. Motion component may comprise of wheels being coupled to substantially a middle portion of the bottom. That is, motion component may comprise of a wide variety of motion components such as, but not limited to, three or more castor type wheels, friction related tracks, and the like. Even though holding components may be illustrated as being provided on a side of a container, holding components may be provided on any number of sides and/or surfaces such as, but not limited to, a lid thereby facilitating holding of one or more implements on a lid including attachments that may be coupled on an existing container. Accordingly to the foregoing, the claimed subject matter is not limited in these respects.

While there has been illustrated and/or described what are presently considered to be example embodiments of claimed subject matter, it will be understood by those skilled in the art that various other modifications may be made, and/or equivalents may be substituted, without departing from the true scope of claimed subject matter. Additionally, many modifications may be made to adapt a particular situation to the teachings of claimed subject matter without departing from subject matter that is claimed. Therefore, it is intended that the patent not be limited to the particular embodiments disclosed, but that it covers all embodiments falling within the scope of the appended claims.

What is claimed is:

1. An apparatus comprising:
a container, the container having a bottom, a side, and a top;
a motion component, the motion component coupled to the bottom;
a lid component, the lid component coupled to the top; and
a holding component, the holding component coupled to the side and
wherein the holding component is capable of holding one or more implements.

2. The apparatus of claim 1, wherein the container comprises a container made of plastic type material.

3. The apparatus of claim 1, wherein the container comprises a container made of metal type material.

4. The apparatus of claim 1, wherein the container comprises a waste bin type container.

5. The apparatus of claim 1, wherein the container comprises a recycling bin type container.

6. The apparatus of claim 1, wherein the container comprises a yard debris bin type container.

7. The apparatus of claim 1, wherein the motion component comprises two wheels coupled to one or more axels transversely coupled to the bottom.

8. The apparatus of claim 7, wherein the axel comprises an axel transversely coupled to substantially one side portion of the bottom.

9. The apparatus of claim 7, wherein the axel comprises an axel transversely coupled to substantially a middle portion of the bottom.

10. The apparatus of claim 1, wherein the motion component comprises three or more castor type wheels coupled to the bottom.

11. The apparatus of claim 1, wherein the container comprises a container having a substantially rectangular shape.

12. The apparatus of claim 1, wherein the container comprises a container having a substantially round shape.

13. The apparatus of claim 1 further comprising a handle located proximate to the top, the handle capable of facilitating pivoting of the container.

14. The apparatus of claim 13, wherein the handle comprises a handle capable of facilitating motion of the container.

15. The apparatus of claim 13, wherein the handle comprises a handle pivotally coupled to the container, the handle capable of swinging substantially along the side of the container.

16. The apparatus of claim 1 further comprising a support, the support capable of facilitating substantial leveling of the container.

17. The apparatus of claim 1, wherein the lid component comprises a lid pivotally coupled to the container, the lid capable of being pivotally opened and closed.

18. The apparatus of claim 1, wherein the lid component comprises a lid capable of holding the one or more implements.

19. The apparatus of claim 18, wherein the lid comprises a lid capable of having the holding component.

20. The apparatus of claim 1, wherein the one or more implements comprises at least one of substantially manually utilized implements or power assisted implements.

21. The apparatus of claim 1 further comprising an opening capable of facilitating removal of material from within the container.

22. The apparatus of claim 1 further comprising an opening capable of facilitating storage.

23. The apparatus of claim 1 further comprising a power supply capable of facilitating utilization of electric devices.

24. The apparatus of claim 23, wherein the power supply comprises a battery type power supply being included with the container.

25. The apparatus of claim 22, wherein the power supply comprises an electric receptacle capable of facilitating reception of an electrical cord.

26. The apparatus of claim 1 further comprising one or more compartments.
